(19) United States
(12) Patent Application Publication
(10) Pub. No.: US 2007/0001806 A1
(43) Pub. Date: Jan. 4, 2007

(54) Alert filtering

(75) Inventor: Leonard H.D. Poll, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA EINDHOVEN (NL)

(21) Appl. No.: 10/553,548

(22) PCT Filed: Apr. 15, 2004
(86) PCT No.: PCT/IB04/01210

§ 371 Date: Oct. 19, 2005

(30) Foreign Application Priority Data
Apr. 24, 2003 (GB) 0309413.3

(51) Int. Cl. G08B 5/22; G06F 15/16

(52) U.S. Cl. 340/7.59; 340/3.71; 709/207; 455/567; 379/88.12

(57) ABSTRACT

A system for handling alerts of an event, the event comprising delivery of data to a user device, comprises a receiver for receiving an event notification, a processor for acquiring information relating to the users likely current activity, for acquiring filtering information, and for comparing the users likely current activity with the filtering information and an output device for outputting an alert to the user dependent upon the comparison of the users likely current activity with the filtering information.

This invention relates to a method of and system for handling alerts to an event. Typically, these events are such things as the receipt of an email or incoming telephone call.

Consumers are increasingly bombarded with alerts such as ‘new emails’, ‘weather forecast’, ‘traffic information’ or more traditional ones such as an analogue phone ringing. Many of these alerts are seen as rude because they interfere with current user activities. Filtering alerts is not a novel topic and several initiatives have been undertaken in this area most of which concentrate on location specific alerts. Location is certainly a good indicator for filtering alerts when a user is out and about but is unfortunately not sufficient for filtering alerts at home. The tendency therefore is to simply not filter alerts at home; this could cause some irritation with the user, which will only grow in the near future as the number of digitally triggered alerts will rise in line with the increased popularity of interconnected devices, or have timed alerts, which are a step forward to ‘giving the user what he wants when he wants it’ but require a user to set these up and modify them as required.

United States patent application publication US 2001/0012286 discloses an apparatus and method for alerting a user upon receipt of selected messages, independent of the type of device generating the message is provided. Message generating devices include telephony devices (telephone, fax machine, etc.), or data devices such as a computer or PDA. All messages are converted into a format compatible with a data network for delivery to a web server. The web server includes a message notification system with message alert type selection and incoming message filtering. A user designates from a computer the types of messages for which s/he wishes to be alerted, and designates how the alert is to be presented on his/her computer. When messages are received by the web server, they are distinguished by message type, and filtered according to the user defined criteria. Selected messages cause a message indication to be generated provided to a program on the user's computer. The program alerts the user, either visually or audibly, depending on user defined criteria, of the number and type of received messages. One alert type of the present invention includes a flashing icon or LED on the users computer system. However, the system described in this document, as with all the known systems, requires the user to indicate the parameters for the filtering of alerts.

It is therefore an object of the invention to improve upon the known art, by providing a system of handling alerts that does not require user creation of the parameters for the filtering of alerts and simply and efficiently handles the incoming alerts.

According to a first aspect of the invention, there is provided a method of handling alerts of an event, the event comprising delivery of data to a user device, comprising receiving an event notification, acquiring information relating to the users likely current activity, acquiring filtering information, comparing the users likely current activity with the filtering information and outputting an alert to the user dependent upon the comparison of the users likely current activity with the filtering information.

According to a second aspect of the invention, there is provided a system for handling alerts of an event, the event comprising delivery of data to a user device, comprising a receiver for receiving an event notification, a processor for acquiring information relating to the users likely current activity, for acquiring filtering information, and for comparing the users likely current activity with the filtering information and an output device for outputting an alert to the user dependent upon the comparison of the users likely current activity with the filtering information.

In the preferred embodiment, the user receives alerts when he is able to whilst minimizing the user system interaction. The willingness to receive certain alerts depends upon the activity a user is engaged in and can depend upon the type of alert. For instance, many people will perceive an incoming phone call during a commercial break on the TV acceptable whereas most will also agree that this is highly undesirable whilst watching a movie on the same TV. This invention addresses this problem by deducting (from, for example, the current state of consumer devices) what activity a user might be engaged in and filtering incoming alerts accordingly.

This input together with the type of alert received is then fed into another self learning artificial intelligence module that gives a prediction of the level of user receptiveness for this type of alert. If the receptiveness is above a certain level, the alert is presented immediately. If the level is below a certain level that the alert is put in a cache. The procedure described above is then executed at regular intervals until the content of the cache is cleared completely.

The problem is not new, but the solution is, as it uses fused data from different sources (electronic programme guide and/or consumer electronics device status) to determine the users likely current activity. This is then in turn used to filter incoming alerts of a diverse nature, not necessarily directly related to any of the information sources used.

Embodiments of the present invention will now be described, by way of example only, with reference to the accompanying drawings, in which:—

FIG. 1 is a schematic diagram of a network of consumer electronics devices and a remote control device,

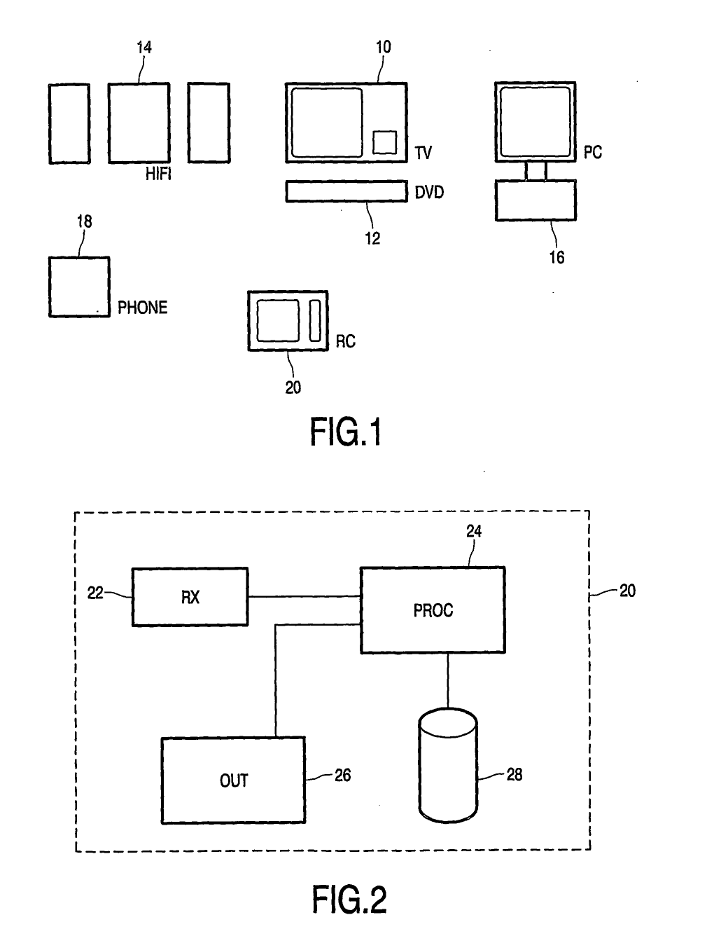

FIG. 2 is a schematic diagram of the remote control device of FIG. 1, and

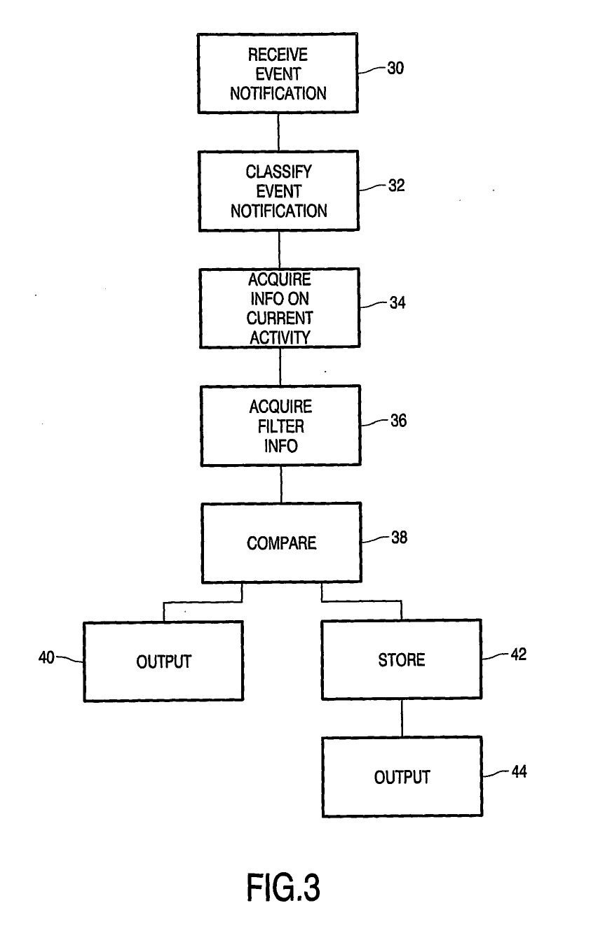

FIG. 3 is a flow diagram of a method of handling alerts of an event.

FIG. 1 illustrates a home network of consumer electronics devices, including a television 10, a DVD player 12, an audio system (HiFi) 14, a personal computer (PC) 16 and a mobile telephone 18. All of the devices in the network are connected to and can be controlled by a remote control device (RC) 20. Traditionally, remote controls have been dedicated devices, with one remote control per device, but global remote control devices have been known for some time. An example of such a remote control is the iPronto device of Philips Electronics. The remote control 20 communicates wirelessly with each device, using a short-range wireless protocol such as 802.11b (WiFi). The communication is a two-way communication, with control signals, data, and state information travelling to and from the remote control 20.

Each of the devices of the network can receive an event. The event comprises delivery of data to the user device. An example of such an event would be, in the case of the mobile phone 18, an incoming telephone call or receipt of a text message. In the case of the PC 16, this might be, for example, receipt of an email, completion of a lengthy download, or notification that a friend is now online. The user is alerted of these events via the remote control 20.

The remote control 20 operates as a system for handling all of the alerts of the events, and is shown in more detail in FIG. 2. The remote control 20 comprises a receiver 22 for receiving the event notifications from each of the user devices that comprise the local network. The remote control 20 also comprises a processor 24. The processor 24 is for acquiring information relating to the users likely current activity, and for acquiring filtering information.

In a preferred embodiment, the processor 24 of the remote control 20 acts as the central device for determining the activity that the user is engaged in on the basis of the status of the local devices and external data such as electronic radio and TV programme guides. When an alert arrives at the remote control 20, the processor 24 is arranged, when acquiring information relating to the users likely current activity, to access information on the current state of one or more user devices by either querying the devices directly if possible or by checking the last known state of each device from the device usage log, which is created by observing the user's behaviour. In the latter case the time passed since the last interaction was performed can be used to assign statistical significance to whether or not any particular device is still in this state (for example, knowing that a TV was last switched to BBC1 12 hours ago indicates that the state of the TV is unknown as the user has probably switched off the device). This state information is fed into a Bayesian network or other artificial intelligence based module that is able to predict user activities on the basis of the input parameters such as device state, time of day, and day of week.

The output of this module within the processor 24 is a predication of the users likely current activity which may be, for example, ‘watching TV, ’ ‘listening to the radio’, or ‘having breakfast’. The processor 24 is arranged, when acquiring filtering information, to retrieve a file. At the most basic level this is a file with the relevant user activities listed, with an indication as to whether the alert should be output or not. As an example, the filtering information would contain such information as “watching DVD—no output” and “listening to the radio—output”. This information can be user determined, in which case the retrieved file is a user profile.

The processor 24 compares the users likely current activity with the filtering information and communicates with an output device 26. The output device 26 is for outputting the alert to the user dependent upon the comparison of the users likely current activity with the filtering information. The output device 26 is typically an audio device to provide an audio alert if the processor 24 has indicated that the user should be alerted to the received event notification. A visual alert can also be presented to the user if desired. In this way the receipt of event alerts are dealt with centrally by the remote control 20, which filters the alerts according to the users likely current activity. Typical of the activities that a user might be engaged in are listed in the following table.

| | |
|---|---|
| Watching TV | Having dinner |
| Watching a soap on the Tv | Reading a book |
| Watching a DVD | Listening to the radio |
| Watching commercials on the TV | Having breakfast |
| Watching the news on the TV | Reading a newspaper |
| Watching a documentary on the TV | Browsing the web |
| Watching sport on the 1V | Listening to music |
| Watching a quiz or game show | On the phone |
| Watching a favourite series on TV | Cooking a meal |

Typical alerts include receiving a new e-mail, receiving a new text message, an update to the weather forecast for today, an incoming phone call, or an incoming fax.

The processor 24 is so arranged that following the step of comparing the users likely current activity with the filtering information, if no alert is output, then the processor 24 stores the alert in a storage device 28. This storage device for storing the alerts is typically a flash memory with random access. The users likely current activity is continually monitored by the remote control 20, and the processor 24 is arranged to output the stored alert if the users likely current activity has changed. For example, if when the processor 24 accesses information on the state of the user devices present in the local network, the processor 24 detects that the DVD player 12 is operating, then it will deduce that the user is currently watching a DVD. The filtering information accessed by the processor 24 indicates that no alert of an event should be outputted when the user is watching DVD, so the alert is stored in the storage device 28. However, the processor 24 is continually monitoring the state of the user devices, and if the processor 24 becomes aware that the DVD player 12 is no longer operating, for longer than a trivial time period, then the alert will be outputted by the remote control 20.

In the above embodiment, the processor 24, having decided on the users likely current activity, compares that information with the filtering information to decided whether to output an alert to the received event notification. However this methodology can be improved to provide a system that has greater flexibility. In this arrangement, the processor 24 is arranged, following the receiver 22 receiving an event notification, to classify the event notification as being of a predetermined type. In a simple version, the predetermined type is one of high, medium or low priority.

By classifying the event notification as being of a particular type, the filtering information can be more complicated, and based upon the different types of events. So rather than the filtering information containing an entry such as “watching TV—no output”, the entry in the filtering information would read “watching TV—output high”, meaning that the alert of the event would only be output if the event notification has been classified as being of the type “high priority”. As an example, an incoming text message may be classified as being of medium priority and an incoming telephone call may be classified as being of high priority. In the example where the processor 24 has determined that the users likely current activity is watching TV, then in the case of an incoming text message, the alert is stored for output latter, whereas if there is an incoming telephone call, then that alert is output immediately to the user by the output device 26.

FIG. 2 is a flowchart summarising the method of operation of the system, being a method of handling alerts of an event, the event comprising delivery of data to a user device. The method, in its simplest form comprises the steps of receiving 30 an event notification, acquiring 34 information relating to the users likely current activity, acquiring 36 filtering information, comparing 38 the users likely current activity with the filtering information and outputting 40 an alert to the user dependent upon the comparison of the users likely current activity with the filtering information.

As discussed above, the step 34 of acquiring information relating to the users likely current activity comprises accessing information on the current state of one or more user devices, and the step 36 of acquiring filtering information comprises retrieving a file. Following the step 38 of comparing the users likely current activity with the filtering information, if no alert is output, the method further comprises storing 42 the alert, and also comprises outputting 44 the stored alert if the users likely current activity has changed.

The method can also include the stage following the step of receiving an event notification, of classifying 32 the event notification as being of a predetermined type. One possible classification scheme involves the predetermined type being one of high, medium or low priority.

1. A method of handling alerts of an event, the event comprising delivery of data to a user device, comprising receiving an event notification, acquiring information relating to the users likely current activity, acquiring filtering information, comparing the users likely current activity with the filtering information and outputting an alert to the user dependent upon the comparison of the users likely current activity with the filtering information.

2. A method according to claim 1, and further comprising, following the step of receiving an event notification, classifying the event notification as being of a predetermined type.

3. A method according to claim 2, wherein the predetermined type is one of high, medium or low priority.

4. A method according to claim 1, wherein the step of acquiring information relating to the users likely current activity comprises accessing information on the current state of one or more user devices.

5. A method according to claim 1, wherein the step of acquiring filtering information comprises retrieving a file.

6. A method according to claim 5, wherein the file is a user profile.

7. A method according to claim 1, wherein following the step of comparing the users likely current activity with the filtering information, if no alert is output, the method further comprises storing the alert.

8. A method according to claim 7, and further comprising outputting the stored alert if the users likely current activity has changed.

9. A system for handling alerts of an event, the event comprising delivery of data to a user device, comprising a receiver for receiving an event notification, a processor for acquiring information relating to the users likely current activity, for acquiring filtering information, and for comparing the users likely current activity with the filtering information and an output device for outputting an alert to the user dependent upon the comparison of the users likely current activity with the filtering information.

10. A system according to claim 9, wherein the processor is arranged, following the receiver receiving an event notification, to classify the event notification as being of a predetermined type.

11. A system according to claim 10, wherein the predetermined type is one of high, medium or low priority.

12. A system according to claim 9, wherein the processor is arranged, when acquiring information relating to the users likely current activity, to access information on the current state of one or more user devices.

13. A system according to claim 9, wherein the processor is arranged, when acquiring filtering information, to retrieve a file.

14. A system according to claim 13, wherein the file is a user profile.

15. A system according to claim 9, and further comprising a storage device for storing the alert.
